(19) United States
(12) Patent Application Publication
(10) Pub. No.: US 2018/0066755 A1
(43) Pub. Date: Mar. 8, 2018

(54) CONTROL DEVICE OF AUTOMATIC TRANSMISSION WHICH EXECUTES SHIFT-BY-WIRE CONTROL

(71) Applicant: MAZDA MOTOR CORPORATION, Hiroshima (JP)

(72) Inventors: Takahiro KIMURA, Hiroshima-shi (JP); Yasuo SHIGENAKA, Otake-shi (JP); Kenji SAWA, Hiroshima-shi (JP); Keitaro KAGEYAMA, Hiroshima-shi (JP); Takashi ISHIYAMA, Higashihiroshima-shi (JP); Masamichi FUJIKAWA, Hatsukaichi-shi (JP)

(73) Assignee: MAZDA MOTOR CORPORATION, Hiroshima (JP)

(21) Appl. No.: 15/677,482

(22) Filed: Aug. 15, 2017

(30) Foreign Application Priority Data
Sep. 6, 2016 (JP) 2016-173501

(51) Int. Cl. F16H 63/34; F16H 61/12

(52) U.S. Cl. CPC F16H 63/3483; F16H 61/12

(57) ABSTRACT

A shift position determination portion determines that operation of shifting a shift position from other range than a parking range to the parking range is conducted. A parking lock command portion causes a piston to maintain a state of being mechanically locked at a second position when the shift position is shifted to the parking range. An actuator drive command portion commands an actuator to drive the piston from the second position to a first position in a state where the position of the piston is mechanically locked at the second position. A parking lock failure determination portion determines that the locking mechanism portion is in a failure in an unlocked state when the position of the piston goes out of the second position within a predetermined time after a command is issued.

### TECHNICAL FIELD

The present invention relates to a control device of a shift-by-wire automatic transmission.

### BACKGROUND ART

A shift-by-wire automatic transmission adopts a structure provided with a mechanical parking lock mechanism portion to allow double security. Specifically, a lock mechanism is provided which maintains other states than a parking state even when an oil pressure is lowered during traveling in a drive range, and prevents the release of the parking state conversely when the oil pressure functions during stop in a parking range.

For such a parking lock mechanism portion as described above, it is necessary to provide a structure for detecting both a failure in a locked state and a failure in an unlocked (lock released) state. Such a structure for detecting a failure of a parking lock mechanism portion is disclosed in JP 2007-303680 A. JP 2007-303680 A discloses a technique of detecting a failure of a parking lock mechanism portion by two sensors, i.e., a first position sensor provided for detecting engagement of a parking pole with a notch of a parking gear and a second position sensor provided for detecting a position of a locking member which locks a position of the parking pole.

However, the technique disclosed in JP 2007-303680 A has problems in terms of manufacturing cost and reliability. Specifically, while an automatic transmission of a vehicle is constantly demanded to reduce the manufacturing cost, according to the technique disclosed in JP 2007-303680 A, the manufacturing cost is increased because the two sensors are provided for detecting a failure of the parking lock mechanism portion.

Additionally, according to the technique disclosed in JP 2007-303680 A, a failure rate is increased because the two sensors are provided.

### SUMMARY OF INVENTION

The present invention, which is intended to solve such problems as described above, aims at providing a control device of an automatic transmission capable of suppressing an increase in manufacturing cost while ensuring high reliability.

A control device of an automatic transmission according to an aspect of the present invention targets an automatic transmission to be controlled which is provided in a power transmission path between a drive source a wheel and includes a power transmission shaft, a parking mechanism portion, an actuator, and a locking mechanism portion.

The power transmission shaft is a shaft which transmits power to the wheel.

The parking mechanism portion is a mechanism portion which enters a restraining state of restraining rotation of the power transmission shaft when a shift position is in a parking range and enters a restraining released state of releasing restraining of the rotation of the power transmission shaft when the shift position is in other range than the parking range.

The actuator has a piston freely movable between a first position and a second position, the piston being coupled to the parking mechanism portion. Then, the actuator brings the parking mechanism portion into the restraining state by setting the piston to the first position, and brings the parking mechanism portion into the restraining released state by setting the piston to the second position.

The locking mechanism portion is a mechanism portion which mechanically locks a position of the piston when the piston of the actuator is at the second position.

The control device of the automatic transmission according to the present aspect is a shift-by-wire control device including a shift position determination portion, a parking lock command portion, an actuator drive command portion, and a parking lock failure determination portion.

The shift position determination portion is a portion which obtains information related to the shift position to determine that operation of shifting the shift position from other range than the parking range to the parking range is conducted.

The parking lock command portion is a portion which commands the locking mechanism portion to maintain a state where a position of the piston is mechanically locked at the second position when the shift position determination portion determines that the operation of shifting the shift position from other range than the parking range to the parking range.

The actuator drive command portion is a portion which commands the actuator to drive the piston from the second position to the first position in a state where the parking lock command portion issues a command to maintain the state where the position of the piston is mechanically locked at the second position.

The parking lock failure determination portion is a portion which, when determining that the position of the piston goes out of the second position within a predetermined time after the actuator drive command portion issues a command to drive the piston, determines that the locking mechanism portion is in a failure in an unlocked state.

The control device of the automatic transmission according the above aspect is capable of suppressing an increase in manufacturing cost while ensuring high reliability.

### BRIEF DESCRIPTION OF DRAWINGS

FIG. 1 is a schematic view showing a part of a structure of a vehicle according to a first embodiment;

FIG. 2 is a schematic perspective view showing structures of a parking mechanism portion and a periphery thereof in an automatic transmission;

FIG. 3 is a schematic front view showing a parking lock released state in the parking mechanism portion;

FIG. 4 is a schematic front view showing a parking locked state in the parking mechanism portion;

FIG. 5 is a schematic block diagram showing a structure related to a control system in the vehicle;

FIG. 6 is a functional block diagram showing a structure of a control unit on a function-by-function basis;

FIG. 7 is a flow chart related to failure determination of a parking lock mechanism portion executed by the control unit;

FIG. 8 is a schematic view showing a state where a parking actuator is locked at other position than a parking position;

FIG. 9 is a schematic view showing a state where the locked parking actuator is released at other position than the parking position;

FIG. 10 is a schematic view showing a state where the locked parking actuator is released at the parking position;

FIG. 11 is a schematic view showing a state where the parking actuator is locked at the parking position;

FIG. 12 is a functional block diagram showing a structure of a control unit on a function-by-function basis, the control unit being provided in a vehicle according to a second embodiment; and

FIG. 13 is a flow chart related to failure determination of a parking lock mechanism portion executed by the control unit.

### DESCRIPTION OF EMBODIMENTS

In the following, description will be made of embodiments of the present invention with reference to the drawings. It should be noted that the embodiments described below are each merely one aspect of the present invention, and the present invention is not limited to the following embodiments except for essential structures thereof.

### First Embodiment

1. Structure of Vehicle 1

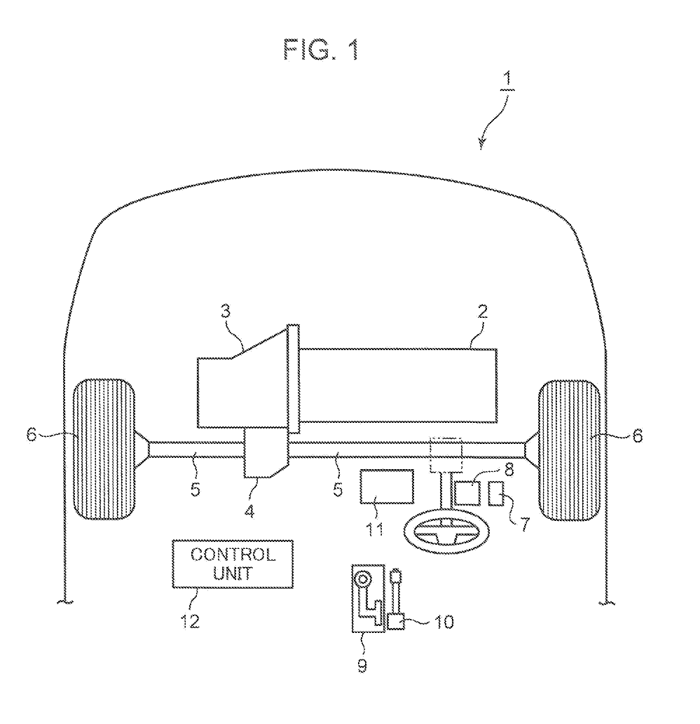

A structure of a vehicle 1 according to the present embodiment will be described with reference to FIG. 1. FIG. 1 is a schematic view showing a part of the structure of the vehicle 1.

As shown in FIG. 1, the vehicle 1 includes an engine 2, an automatic transmission 3, a differential gear 4, a drive shaft 5, and a wheel 6.

The engine 2, which is provided as a drive source in the vehicle 1, is an internal combustion engine that internally burns fuel to obtain power. Although a type of the engine 2 is not particularly limited, a four-cycle multicylinder gasoline engine is adopted as one example. A crank shaft of the engine 2 is coupled to the automatic transmission 3.

The automatic transmission 3 is a continuously variable transmission or a planetary gear automatic transmission which transmits rotation of the crank shaft of the engine 2 to the drive shaft 5 while reducing the rotation. The vehicle 1 according to the present embodiment is, a so-called front engine-front drive (FF) vehicle, and the automatic transmission 3 is integrally configured with the differential gear 4 as a differential device. Power from the engine 2 has rotation reduced by the automatic transmission 3 and transmitted to the drive shaft 5 from an output shaft (illustration thereof is omitted in FIG. 1) via the differential gear 4.

Additionally, the vehicle 1 includes an accelerator pedal 7, a brake pedal 8, a shift unit 9, a parking brake 10, an information display (warning output portion) 11, and a control unit (control device) 12.

The shift unit 9 is provided with a parking (P) range, a reverse (R) range, a neutral (N) range, a drive (D) range, and a manual (M) range, though detailed illustration thereof is omitted. In the present specification, the respective ranges such as the reverse (R) range, the neutral (N) range, the drive (D) range, and the manual (M) range other than the parking (P) range may be collectively referred to as a range (N-parking range) other than the parking range.

The information display (warning output portion) 11 is a device which transmits various kinds of information to a driver, and also conducts warning display on the basis of a command from the control unit 12.

The control unit 12 executes control of the engine 2 and control of the automatic transmission 3 to cause the information display 11 to display various information including warning. In the vehicle 1 according to the present embodiment, control of the automatic transmission 3 is conducted on a shift-by-wire basis.

2. Structure of Parking Mechanism Portion 39 and Periphery Thereof in Automatic Transmission 3

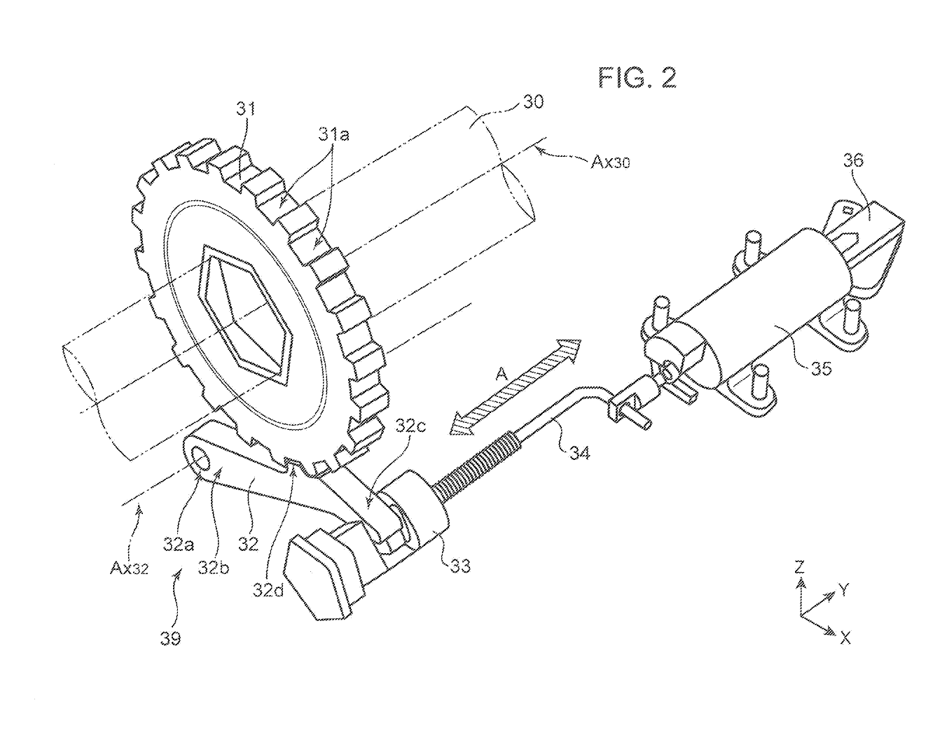

The automatic transmission 3 is provided with a parking mechanism portion 39 which is controlled by the control unit 12. The parking mechanism portion 39 will be described with reference to FIG. 2 to FIG. 4.

As shown in FIG. 2, the parking mechanism portion 39 of the automatic transmission 3 has a parking gear 31 and a parking pole 32.

The parking gear 31 has an annular shape and a hole portion provided therein into which an output shaft 30 is fit. The parking gear 31 is rotatable around an axis Ax30 integrally with the output shaft 30.

The output shaft 30 is a power transmission shaft provided in a power transmission path which transmits power to the wheel 6.

In an outer circumferential portion of the parking gear 31, a plurality of notches 31a is made in a circumferential direction.

The parking pole 32 has an insertion hole 32a formed in a base portion 32b, into which a shaft not shown is inserted. Then, the parking pole 32 has a front end portion 32c which freely rises and falls centered around a hole axis Ax32 of the insertion hole 32a.

In the parking pole 32, a protrusion portion 32d protruding toward the parking gear 31 is provided in a middle part between the base portion 32b and the front end portion 32c in an X direction. The protrusion portion 32d is formed to have a size enabling engagement with the notch 31a of the parking gear 31.

The parking mechanism portion 39, which has the parking gear 31 and the parking pole 32, is provided with a parking cam 33, a parking rod 34, a parking actuator 35, a parking position sensor 36, and a parking lock solenoid (illustration thereof is omitted in FIG. 2 to FIG. 4).

The parking cam 33 has a surface of contact, as a cam surface, with the front end portion 32c of the parking pole 32. The parking cam 33 is configured such that movement thereof in a Y direction causes the front end portion 32c of the parking pole 32 to rise and fall.

The parking rod 34 is a rod-shaped member which couples the parking cam 33 and the parking actuator 35. The parking rod 34 moves in the Y direction as indicated by an arrow A along with drive of the parking actuator 35.

The parking actuator 35 executes push/pull (advance/retreat) of the parking rod 34 by supply and discharge of an oil pressure to/from a hydraulic chamber.

The parking position sensor 36 is a sensor for detecting a position of a piston of the parking actuator 35. Specifically, the piston of the parking actuator 35 is capable of outputting electrical signals, which are different at a first position and a second position, as detection information. The detection information is sent to the control unit 12.

Here, when the piston of the parking actuator 35 is at the most retreated position in the Y direction (the second position), the engagement between the notch 31a of the parking gear 31 and the protrusion portion 32d of the parking pole 32 is released, so that the rotation of the output shaft 30 is not restrained (a restraining released state).

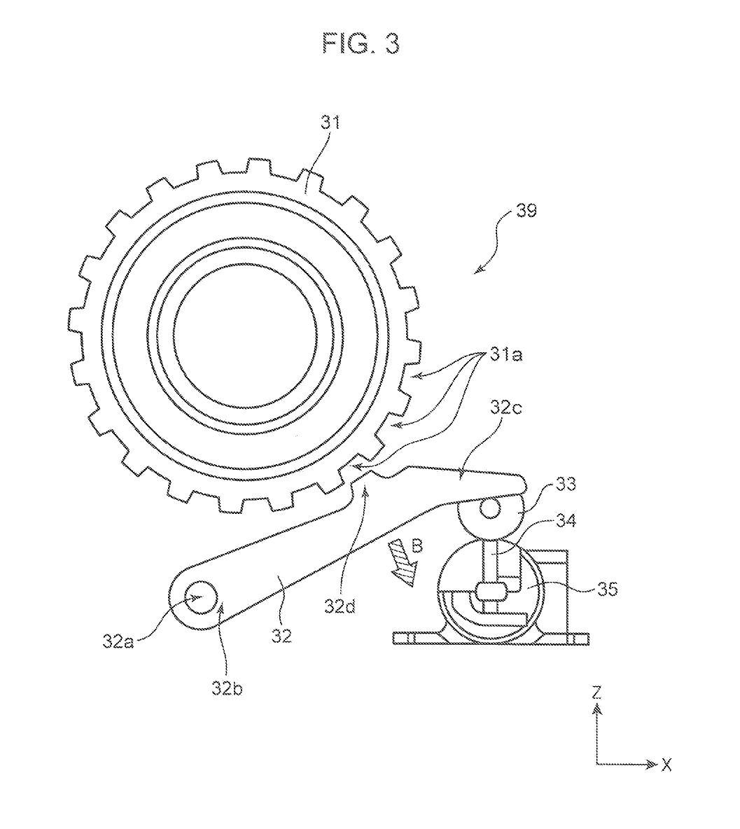

Specifically, when the piston of the parking actuator 35 is at the most retreated position in the Y direction (the second position), the parking pole 32 enters a state of being apart from the parking gear 31 as indicated by an arrow B in FIG. 3. As a result, the engagement between the notch 31a of the parking gear 31 and the protrusion portion 32d of the parking pole 32 is released. This brings about a state where the rotation of the output shaft 30 is not restrained (the restraining released state).

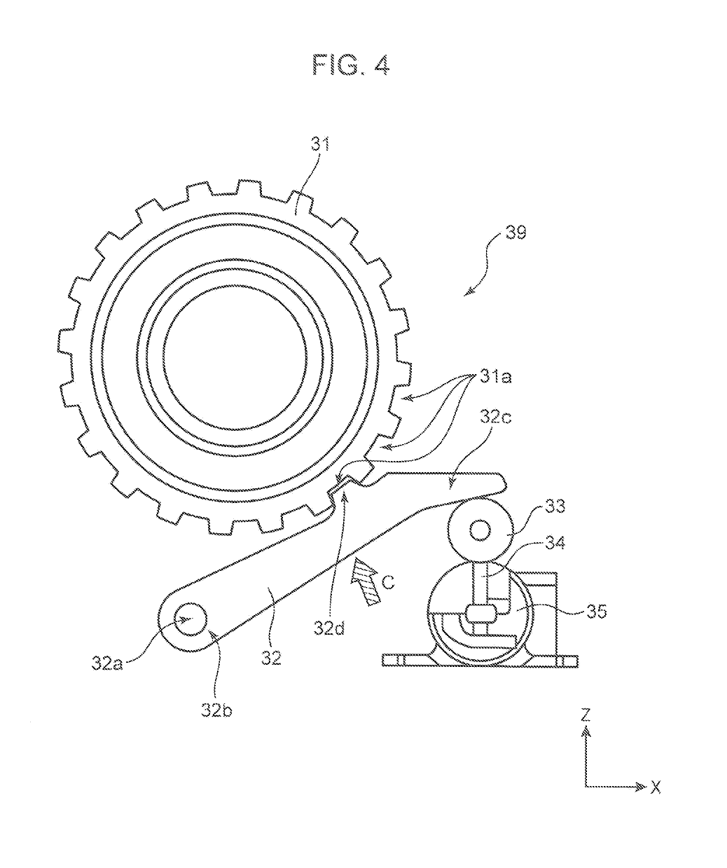

On the other hand, when the piston of the parking actuator 35 is at the most advanced position in the Y direction (the first position), as shown in FIG. 4, the parking pole 32 enters a state of being pushed to the side of the parking gear 31 as indicated by an arrow C. As a result, the notch 31a of the parking gear 31 and the protrusion portion 32d of the parking pole 32 are engaged. When the notch 31a of the parking gear 31 and the protrusion portion 32d of the parking pole 32 are thus engaged, the rotation of the output shaft 30 is restrained (a restraining state).

3. Structure Related to Control System in Vehicle 1

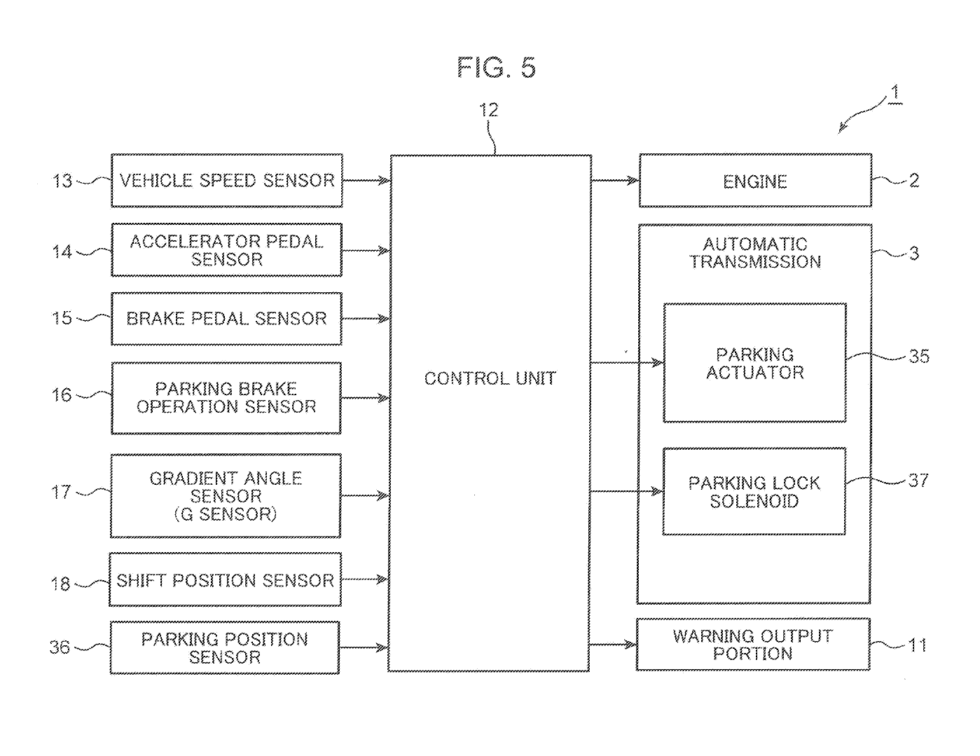

A structure related to a control system in the vehicle 1 will be described with reference to FIG. 5. FIG. 5 is a schematic block diagram showing the structure related to the control system in the vehicle 1.

In the vehicle 1, the control unit 12 is designed to sequentially receive input of various information from a plurality of sensors. Specifically, as shown in FIG. 5, the vehicle 1 is provided with a vehicle speed sensor 13, an accelerator pedal sensor 14, a brake pedal sensor 15, a parking brake operation sensor 16, a gradient angle sensor (G sensor) 17, a shift position sensor 18, and the parking position sensor 36, so that detection information is sequentially input from the respective sensors 13 to 18, and 36 to the control unit 12.

The vehicle speed sensor 13 is a sensor which detects a speed of the vehicle 1.

The accelerator pedal sensor 14 is a sensor for detecting a stepping-down amount (accelerator open degree) of the accelerator pedal 7 (see FIG. 1) by a driver.

The brake pedal sensor 15 is a sensor for detecting a pressure of a brake fluid (brake pressure) when the driver steps down the brake pedal 8 (see FIG. 1).

The parking brake operation sensor 16 is a sensor for detecting a state of the parking brake 10 when the parking brake 10 (see FIG. 1) is operated by the driver.

The gradient angle sensor (G sensor) 17 is a sensor for detecting whether the vehicle 1 inclines in a front-rear direction or not.

The shift position sensor 18 is a sensor for detecting which range is selected by the shift unit 9 (see FIG. 1) from among the parking (P) range, the reverse (R) range, the neutral (N) range, the drive (D) range, and the manual (M) range.

The parking position sensor 36 is as described above.

The control unit 12 executes various arithmetic operations on the basis of input information from the above respective sensors 13 to 18, and 36 to sequentially output control commands to the engine 2, the automatic transmission 3, and the warning output portion 11. Of these commands, the control command to the engine 2 is in practice issued to a throttle valve, a variable valve mechanism, an ignition plug, and a fuel jet valve connected to the engine 2.

The automatic transmission 3 includes the above-described parking actuator 35 and a parking lock solenoid 37, and the control unit 12 executes control thereof.

The control unit 12 outputs various warning information to the information display (warning output portion) 11 to cause the display to display the warning.

4. Functional Structure of Control Unit 12

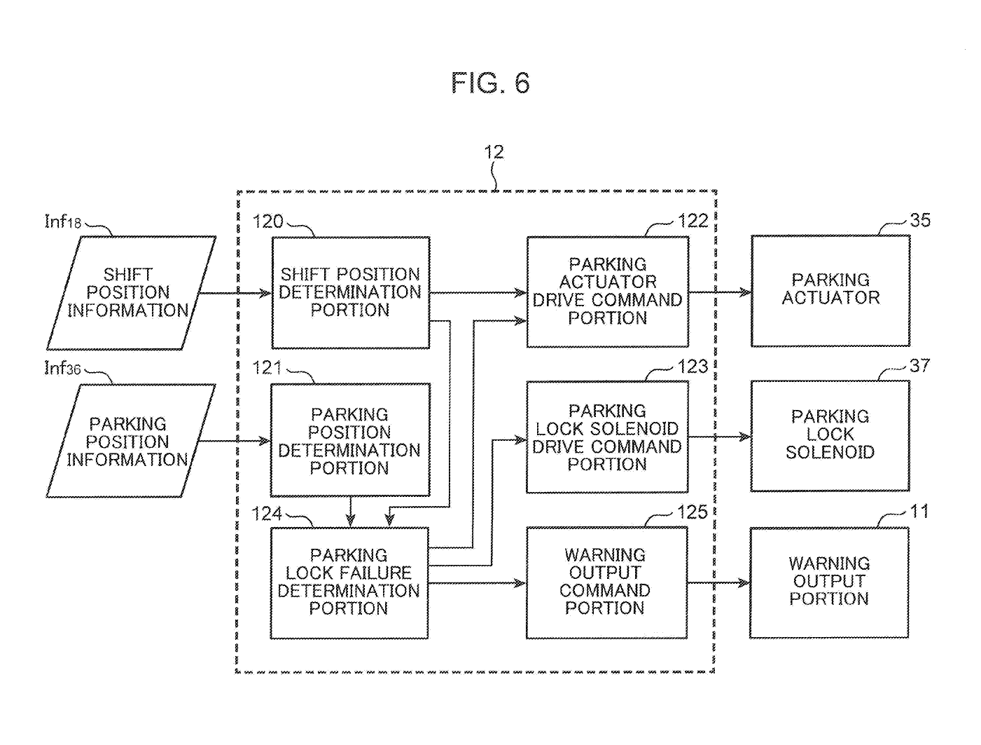

A functional structure of the control unit 12 will be described with reference to FIG. 6. FIG. 6 is a functional block diagram showing a structure of the control unit 12 on a function-by-function basis.

As shown in FIG. 6, the control unit 12 has, as functional structures, a shift position determination portion 120, a parking position determination portion 121, a parking actuator drive command portion 122, a parking lock solenoid drive command portion 123, a parking lock failure determination portion 124, and a warning output command portion 125.

The shift position determination portion 120 sequentially obtains shift position information Inf₁₈ from the shift position sensor 18 (see FIG. 5) to determine which range is selected from among the parking (P) range, the reverse (R) range, the neutral (N) range, the drive (D) range, and the manual (M) range.

The parking position determination portion 121 sequentially obtains parking position information Inf₃₆ from the parking position sensor 36 (see FIG. 2) to determine at which of the first position (advanced position) and the second position (retreated position) a piston is located in the parking actuator 35 (see FIG. 2).

The parking actuator drive command portion 122 issues a drive command to the parking actuator 35. The parking lock solenoid drive command portion 123 issues a drive command to the parking lock solenoid 37 whose specific structure will be described later.

The parking lock failure determination portion 124 determines whether a parking lock mechanism portion including the parking lock solenoid 37 is in failure in an unlocked state (a released state) or not on the basis of a determination result obtained by the shift position determination portion 120 and a determination result obtained by the parking position determination portion 121.

When the parking lock failure determination portion 124 determines that the parking lock mechanism portion including the parking lock solenoid 37 is in failure in the unlocked state, the warning output command portion 125 causes the information display (warning output portion) 11 to display information related to the failure.

5. Method for Determining Failure of Parking Lock Mechanism Portion by Control Unit 12

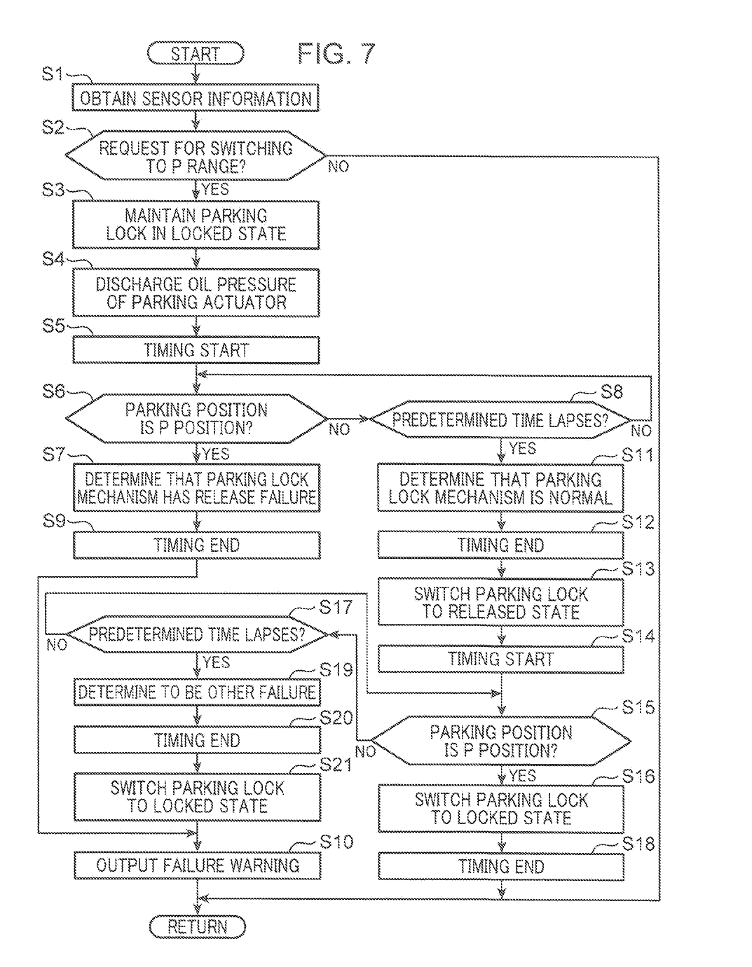

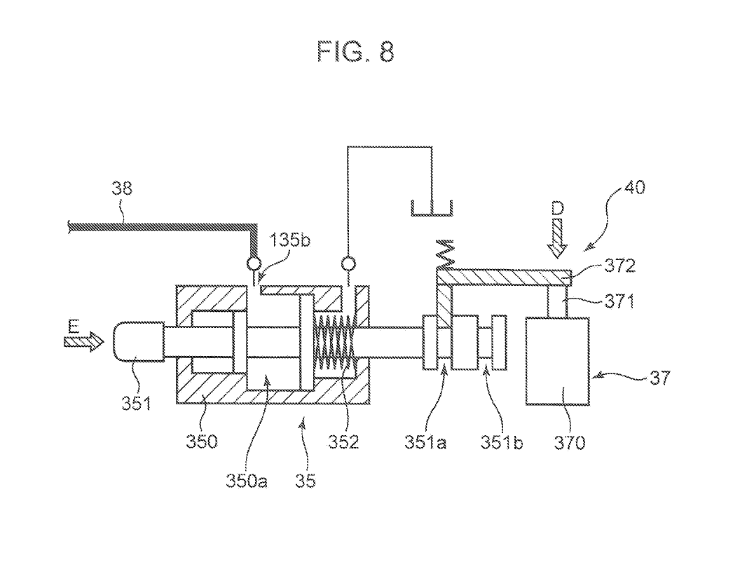

A method for determining a failure of the parking lock mechanism portion 40 executed by the control unit 12 will be described with reference to FIG. 7 to FIG. 11. FIG. 7 is a flow chart related to failure determination of the parking lock mechanism portion 40 executed by the control unit 12, and FIG. 8 to FIG. 11 are schematic views showing a state of the parking actuator 35 and a state of the parking lock mechanism portion 40 in respective conditions.

First, one example described below with reference to FIG. 7 relates to a failure determination method in a case where the shift position is shifted from the N-parking range to the parking range. Description will be made of states of the parking actuator 35 and the parking lock solenoid 37 in a case where the shift position is in the N-parking range, for example, in the D range, with reference to FIG. 8.

As shown in FIG. 8, when the N-parking range is selected, a piston 351 of the parking actuator 35 is at the retreated second position as indicated by an arrow E. In a state where the piston 351 is at the second position, as described with reference to FIG. 3, the parking pole 32 is apart from the parking gear 31 and the engagement between the notch 31a of the parking gear 31 and the protrusion portion 32d of the parking pole 32 is released (the restraining released state).

Additionally, when the N-parking range is selected as shown in FIG. 8, for double security, a plunger 371 of the parking lock solenoid 37 retreats to a position indicated by an arrow D, so that a front end portion of a lock pawl member 372 is engaged with a groove portion 351a provided in the piston 351.

As shown in FIG. 7, the control unit 12 first sequentially obtains various sensor information (Step S1). The obtained information is as described with reference to FIG. 5. Then, when the operation of shifting the shift position from the N-parking range to the parking range is conducted (Step S2:Yes), the control unit 12 issues a command to the parking lock solenoid 37 to maintain a locked state of the parking lock mechanism portion (Step S3). Specifically, as shown in FIG. 8, the front end portion of the lock pawl member 372 is caused to maintain the engagement with the groove portion 351a of the piston 351.

Returning to FIG. 7, with the parking lock mechanism portion maintained in the locked state, a command is issued to the parking actuator 35 to discharge an oil pressure (Step S4). Specifically, as shown in FIG. 8, the parking actuator 35 is caused to discharge the oil pressure from a hydraulic chamber 350a in a cylinder tube 350 via a port 135b and a hydraulic pipe 38.

Then, after issuing a command to discharge the oil pressure, the control unit 12 starts timing by using a timer provided therein or the like (Step S5). This is because after issuing the command to discharge the oil pressure (Step S4), a predetermined time is required until the oil pressure in the hydraulic chamber 350a is decreased to or below a predetermined value.

Next, the control unit 12 determines whether or not a position of the piston 351 of the parking actuator 35 is moved to a parking position (the first position), in other words, whether or not the position of the piston 351 deviates from a parking released position (the second position) shown in FIG. 8, on the basis of information from the parking position sensor 36 (Step S6). This determination (Step S6) is continued from the start of timing at Step S5 until a predetermined time elapses (Step S8: No).

Here, in a case where the parking lock mechanism portion 40 functions normally, the front end portion of the lock pawl member 372 is engaged with the groove portion 351a of the piston 351 as shown in FIG. 8, so that the piston 351 will not move.

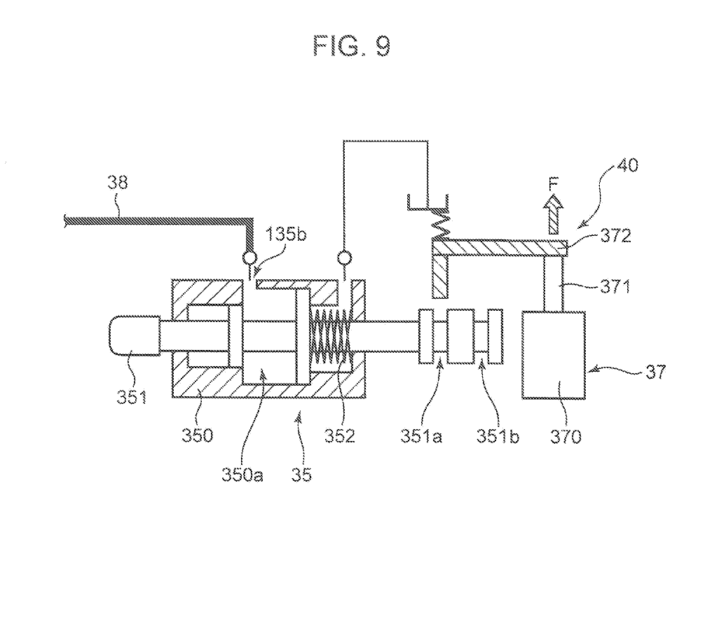

However, when the parking lock mechanism portion 40 stops in the unlocked state (the released state) for some reason, i.e., when the front end portion of the lock pawl member 372 and the groove portion 351a of the piston 351 are out of engagement (e.g., in a case of such a state as shown in FIG. 9), the piston 351 receives an elastic force of a return spring 352 to move (advance) to the parking (P) position (the first position) (Step S6:Yes).

Thus, when determining that the piston 351 is moved to the parking (P) position (the first position) (Step S6: Yes), the control unit 12 determines that “the parking lock mechanism portion 40 has an unlock failure (release failure)” (Step S7) to end the timing (Step S9). Then, the control unit 12 causes the information display (warning output portion) 11 to output failure warning (Step S10). The failure warning by the information display (warning output portion) 11 is designed to continue irrespective of on/off of an ignition switch, and is designed to be released after inspection or repair at a maintenance workshop.

On the other hand, when a predetermined time has elapsed with the determination at Step S6 being “No” (Step S8: Yes), the control unit 12 determines that “the parking lock mechanism portion 40 normally functions” (Step S11) to end the timing (Step S12).

Next, the control unit 12 issues a command to the parking lock solenoid 37 to switch the parking lock mechanism portion 40 to the released state (Step S13). The parking lock solenoid 37 having received the command causes the plunger 371 to advance as indicated by an arrow F, as shown in FIG. 9. As a result, the lock pawl member 372 also moves to the side indicated by the arrow F to release the engagement between the front end portion and the groove portion 351a of the piston 351.

Then, after issuing the command of Step 13, the control unit 12 starts the timing by the timer (Step S14).

Returning to FIG. 7, the control unit 12 determines whether or not a position of the piston 351 of the parking actuator 35 is moved to the parking position (the first position) on the basis of information from the parking position sensor 36 (Step S15). This determination (Step S15) is also continued from the start of timing at Step S14 until a predetermined time elapses (Step S17: No).

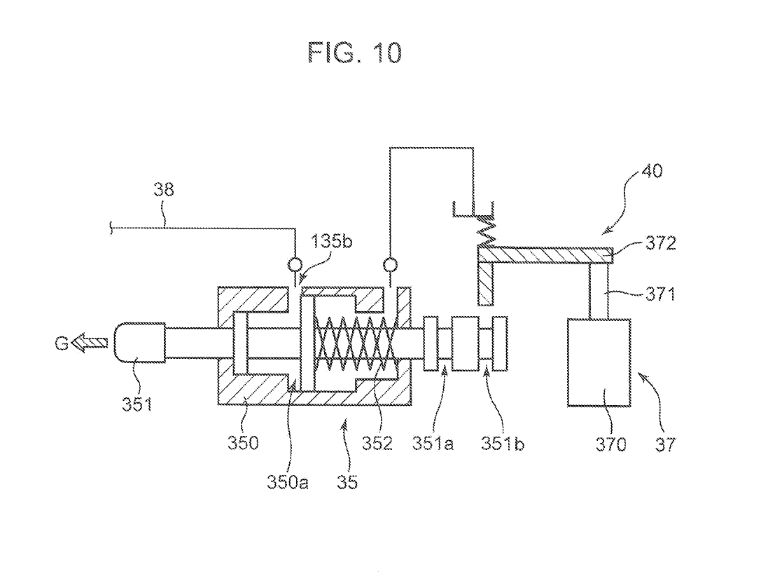

When the position of the piston 351 of the parking actuator 35 moves to the parking position (the first position)(Step S15: Yes), the control unit 12 issues a command to the parking lock solenoid 37 to bring the parking lock mechanism portion 40 into the locked state (Step S16). Specifically, when the engagement between the front end portion of the lock pawl member 372 and the groove portion 351a of the piston 351 is released to discharge the oil pressure of the hydraulic chamber 350a as shown in FIG. 9, the piston 351 moves as indicated by an arrow G due to the elastic force of the return spring 352 as shown in FIG. 10. This is because a pressing force to a wall surface (first surface) of the piston 351 on the side of the hydraulic chamber 350a becomes relatively lower relative to the elastic force of the return spring 352 to an opposite wall surface (second surface).

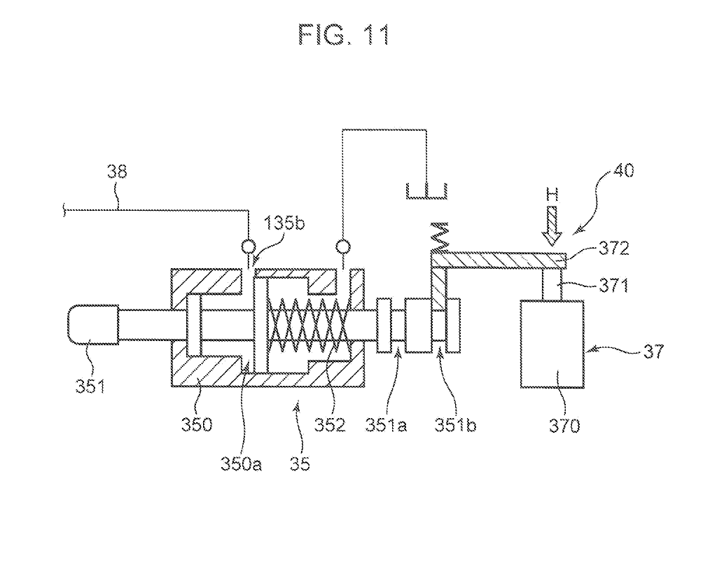

Then, when the piston 351 finishes moving as shown in FIG. 10, the control unit 12 issues a command to the parking lock solenoid 37, and as shown in FIG. 11, the parking lock solenoid 37 having received the command causes the plunger 371 to retreat as indicated by an arrow H. As a result, the lock pawl member 372 also moves to the side indicated by the arrow H, so that the front end portion thereof is brought into engagement with a groove portion 351b of the piston 351.

When a predetermined time has elapsed with the determination at Step S15 being “No” (Step S17: Yes), the control unit 12 determines that “a failure occurs at other position than the parking lock mechanism portion 40” (Step S19) to end the timing (Step S20). In other words, “when a predetermined time has elapsed with the determination at Step S15 being “No” (Step S17: Yes)” means that even when the engagement between the front end portion of the lock pawl member 372 and the groove portion 351a of the piston 351 is released as shown in FIG. 9 to issue a command to the parking actuator 35 to discharge the oil pressure of the hydraulic chamber 350a, the piston 351 fails to enter such a state of moving as shown in FIG. 10.

Possible cases where the control unit 12 makes such determination as described above at Step S19 include, for example, a case of failures of the hydraulic pipe 38 and a hydraulic pump connected thereto and a case of a failure of the parking actuator 35.

Returning to FIG. 7, when making such determination as in Step S19, the control unit 12 issues a command to the parking lock solenoid 37 to switch the parking lock mechanism portion 40 into the locked state (Step S21). As a result, as shown in FIG. 8, the front end portion of the lock pawl member 372 returns to a state of being engaged with the groove portion 351a of the piston 351.

Returning to FIG. 7, after issuing the command at Step S21, the control unit 12 causes the information display (warning output portion) 11 to output a warning that “a failure occurs at other position than the parking lock mechanism portion” (Step S10).

Similarly to the above, this failure warning is also designed to continue irrespective of on/off of an ignition switch, and is designed to be released after inspection or repair at a maintenance workshop.

6. Effect

In the present embodiment, a failure of the parking lock solenoid 37 and a supplementary portion thereof in the unlocked state can be detected using the parking position sensor 36 attached to the parking actuator 35, even when a sensor for detecting the locked state or the unlocked state is not provided to the parking lock solenoid 37 and the supplementary portion thereof. Accordingly, as compared with the technique disclosed in JP 2007-303680 A, the number of sensors provided can be reduced.

Therefore, in the present embodiment, by adopting the control unit 12 which executes such failure determination as described above, an increase in manufacturing cost can be suppressed while high reliability is ensured.

Additionally, in the present embodiment, the oil pressure in the hydraulic chamber 350a of the parking actuator 35 is discharged, so that the piston 351 moves to the position shown in FIG. 10 to enter the restraining state where the rotation of the output shaft 30 in the automatic transmission 3 is restrained. Accordingly, even when there occurs a situation where no oil pressure can be supplied for some reason, the structure of the present embodiment enables the piston 351 to move to the parking position (the first position shown in FIG. 10) by the elastic force of the return spring 352, thereby brining about a state where the rotation of the output shaft 30 in the automatic transmission 3 is restrained.

Thus, the present embodiment is advantageous in ensuring higher safety.

### Second Embodiment

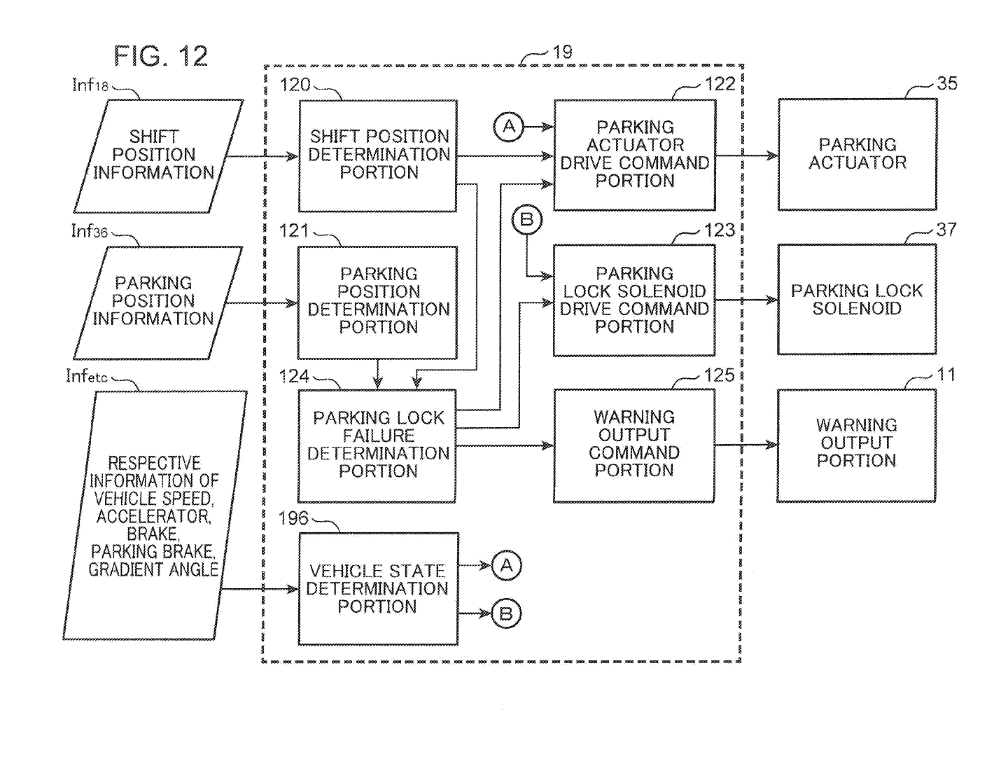

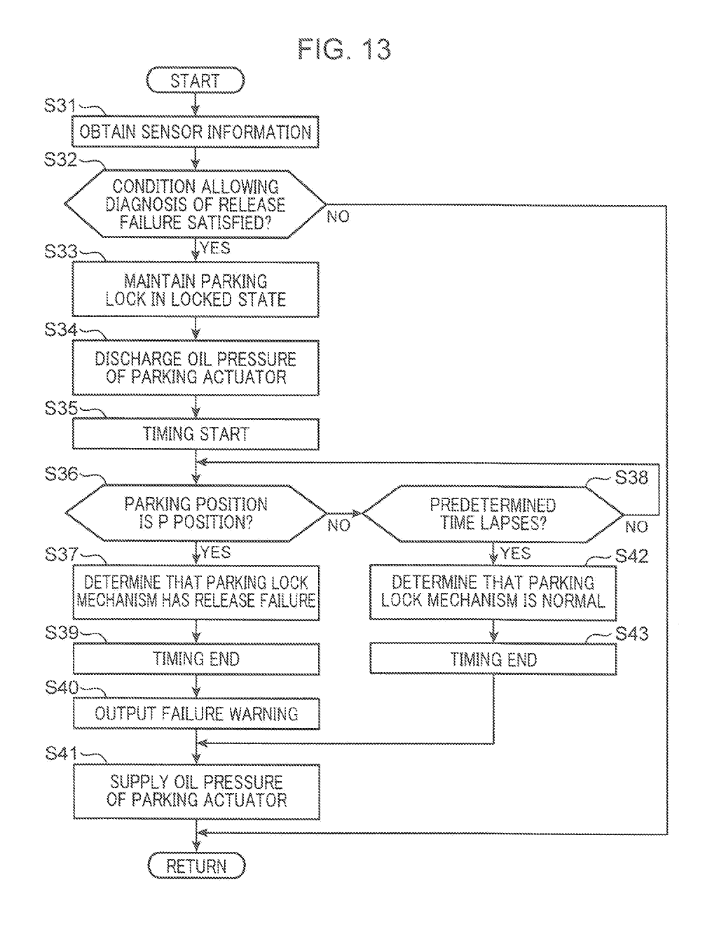

A second embodiment will be described with reference to FIG. 12 and FIG. 13.

1. Structure of Control Unit 19

First, description will be made of a structure of a control unit 19, which is different from that of the vehicle 1 according to the first embodiment, out of a structure of a vehicle according to the present embodiment with reference to FIG. 12. FIG. 12 is a functional block diagram showing the structure of the control unit 19 on a function-by-function basis. In FIG. 12, the same functional parts as those of the control unit 12 of the first embodiment are denoted by the same reference numerals to omit redundant description thereof.

As shown in FIG. 12, the control unit 19 of the vehicle according to the present embodiment includes a vehicle state determination portion 196, in addition to the functional portions provided in the control unit 12 of the vehicle 1 according to the first embodiment.

The vehicle state determination portion 196 is configured to sequentially receive input of various information Inf_{etc} such as information related to a vehicle speed from a vehicle speed sensor 13, information related to an accelerator open degree from an accelerator pedal sensor 14, information related to a brake pressure from a brake pedal sensor 15, information related to a state of a parking brake 10 from a parking brake operation sensor 16, and information related to an inclination of a vehicle from a gradient angle sensor (G sensor) 17.

The vehicle state determination portion 196 in the control unit 19 is a functional portion which determines whether or not a failure diagnosis of a parking lock mechanism portion 40 in an automatic transmission 3 in an unlocked state is available even when a shift position is in an N-parking range.

As shown in FIG. 12, the control unit 19 has the same structure as that of the control unit 12 of the vehicle 1 according to the first embodiment, except that the control unit 19 further includes the vehicle state determination portion 196. Therefore, the same effect as in the first embodiment can be obtained.

2. Method for Determining Failure of Parking Lock Mechanism Portion 40 by Control Unit 19

Description will be made of a method for determining a failure of the parking lock mechanism portion 40 executed by the control unit 19 when the shift position is in the N-parking range, with reference to FIG. 13.

First, one example described below with reference to FIG. 13 relates to a failure determination method in a case where the shift position is maintained in the N-parking range.

As shown in FIG. 13, the control unit 19 sequentially obtains various information as described above (Step S31). Next, the control unit 19 determines whether the parking lock mechanism portion 40 is in a state of allowing determination whether or not the parking lock mechanism portion 40 is in a failure in the unlocked state (Step S32).

Specifically, when such conditions that a vehicle stops, an accelerator pedal 7 is not depressed, a brake pedal 8 is depressed or a parking brake 10 is applied, and a gradient angle is less than a predetermined angle are satisfied, the control unit 19 determines that the parking lock mechanism portion 40 is in the state of allowing determination whether or not the parking lock mechanism portion 40 is in a failure in the unlocked state (Step S32: Yes).

Conditions to be taken into consideration by the control unit 19 in the determination at Step S32 may not necessarily include all the conditions described above. In short, it is only necessary that the conditions ensure safety when determining whether or not the parking lock mechanism portion 40 is in a failure in the unlocked state.

Subsequently, as shown in FIG. 13, when determining that the parking lock mechanism portion 40 is in the state of allowing determination whether or not the parking lock mechanism portion 40 is in a failure in the unlocked state (Step S32: Yes), the control unit 19 issues a command to a parking lock solenoid 37 to maintain the locked state of the parking lock mechanism portion 40 (Step S33). Specifically, as shown in FIG. 8, a front end portion of a lock pawl member 372 is caused to maintain engagement with a groove portion 351a of a piston 351 as described above.

Then, the control unit 19 causes a parking actuator 35 to discharge an oil pressure from a hydraulic chamber 350a (Step S34) to start timing by a timer (Step S35). At this time, as shown in FIG. 8, when the parking lock mechanism portion 40 normally functions, the front end portion of the lock pawl member 372 is engaged with the groove portion 351a of the piston 351, so that the piston 351 will not move (Step S36: No). Determination making at Step S36 is continued until a predetermined time elapses (Step S38: No). The reason is as described above.

When determining at Step S36 that the piston 351 moves to a parking position (first position) (Step S36: Yes), the control unit 19 determines that “the parking lock mechanism portion 40 is in an unlock failure (release failure)” (Step S37) to end the timing by the timer (Step S39).

Then, the control unit 19 issues a command to an information display (warning output portion) 11 to display a warning that “the parking lock mechanism portion 40 is in the unlock failure (release failure)” (Step S40), similarly to the first embodiment.

Lastly, the control unit 19 causes supply of an oil pressure to the hydraulic chamber 350a of the parking actuator 35 (Step S41) to end the failure determination of the parking lock mechanism portion 40.

Also in the present embodiment, once displayed failure warning is designed to continue irrespective of on/off of an ignition switch, and is designed to be released after inspection or repair at a maintenance workshop.

On the other hand, when a predetermined time has elapsed with the determination at Step S36 being “No” (Step S38: Yes), the control unit 19 determines that “the parking lock mechanism portion 40 normally functions” (Step S42) to end the timing (Step S43). Then, the control unit 19 causes supply of an oil pressure to the hydraulic chamber 350a of the parking actuator 35 (Step S41) to end the failure determination of the parking lock mechanism portion 40.

3. Effect

As described above, in the present embodiment, the parking lock mechanism portion 40 can execute an unlock failure determination when such a condition as vehicle stop is satisfied, even if the shift position remains in the N-parking range. Therefore, in the present embodiment, in addition to the effect obtained by the first embodiment, failure check of the locking mechanism portion in the unlocked state can be executed with high frequency, which is advantageous in ensuring high reliability.

The unlock failure determination of the parking lock mechanism portion 40 in the present embodiment may be executed at all the timings satisfying the above conditions or may be executed at fixed intervals. When executing the determination at fixed intervals, the control unit 19 can be provided with a so-called calendar timer to make a determination in each period scheduled in advance.

### [Modification]

While in the first embodiment and the second embodiment, an FF (front engine-front drive) car mounted with a gasoline engine (engine 2) is adopted as one example of a vehicle, the present invention is not limited thereto. As an engine, for example, a diesel engine can be adopted. The present invention is also applicable to a hybrid electric vehicle provided with an engine and an assisting motor as a power source.

Additionally, vehicle types to which the present invention is applicable include an FR car (front engine-rear drive car), an RR car (rear engine-rear drive car), an MR car (midship engine-rear drive car), a 4WD car (four-wheel drive car).

Additionally, although the structure of the automatic transmission 3 is not particularly described in detail in the first embodiment and the second embodiment, a torque converter automatic transmission may be adopted, or a semi-automatic transmission or a double clutch transmission may be adopted, for example.

Additionally, although the engagement between the parking gear 31 and the parking pole 32 and the release of the engagement are conducted via the parking cam 33 in the first embodiment and the second embodiment, the present invention is not limited thereto. For example, with the end portion of the piston 351 of the parking actuator 35 coupled with the front end portion 32c of the parking pole 32, the parking pole 32 may rise and fall directly by advance and retreat of the piston 351.

Although the control unit 19 executes failure determination on the basis of such obtained information as shown in FIG. 5 even when the shift position remains in the N-parking range in the second embodiment, other various conditions may be added to the conditions for executing the failure determination. For example, with a structure provided with a function of sensing a distance to a preceding car by a camera, radar or the like, a condition can be added that a distance to a preceding car is not less than a predetermined interval. This enables further higher safety to be ensured.

Additionally, although a hydraulic actuator which drives the piston 351 by supply/discharge of an oil pressure is adopted as the parking actuator 35 in the first embodiment and the second embodiment, the present invention is not limited thereto. For example, a motor-driven actuator or an air pressure actuator can be adopted. Additionally, not only a direct-acting actuator but also a rotation-type actuator can be adopted.

### [Conclusion]

A control device of an automatic transmission according to an aspect of the present invention targets an automatic transmission to be controlled which is provided in a power transmission path between a drive source and a wheel and includes a power transmission shaft, a parking mechanism portion, an actuator, and a locking mechanism portion.

The power transmission shaft is a shaft which transmits power to the wheel.

The parking mechanism portion is a mechanism portion which enters a restraining state of restraining rotation of the power transmission shaft when a shift position is in a parking range, and enters a restraining released state of releasing restraining of the rotation of the power transmission shaft when the shift position is in other range than the parking range.

The actuator has a piston freely movable between a first position and a second position, the piston being coupled to the parking mechanism portion. Then, the actuator brings the parking mechanism portion into the restraining state by setting the piston to the first position, and brings the parking mechanism portion into the restraining released state by setting the piston to the second position.

The locking mechanism portion is a mechanism portion which mechanically locks a position of the piston when the piston of the actuator is at the second position.

The control device of the automatic transmission according to the present aspect is a shift-by-wire control device including a shift position determination portion, a parking lock command portion, an actuator drive command portion, and a parking lock failure determination portion.

The shift position determination portion is a portion which obtains information related to the shift position to determine that the operation of shifting the shift position from other range than the parking range to the parking range is conducted.

The parking lock command portion is a portion which commands the locking mechanism portion to maintain a state where a position of the piston is mechanically locked at the second position when the shift position determination portion determines that the operation of shifting the shift position from other range than the parking range to the parking range is conducted.

The actuator drive command portion is a portion which commands the actuator to drive the piston from the second position to the first position in a state where the parking lock command portion issues a command to maintain the state where the position of the piston is mechanically locked at the second position.

The parking lock failure determination portion is a portion which, when determining that the position of the piston goes out of the second position within a predetermined time after the actuator drive command portion issues a command to drive the piston, determines that the locking mechanism portion is in a failure in an unlocked state.

In the control device of the automatic transmission according to the present aspect, when the operation of shifting the shift position from other range than the parking range (hereinafter, referred to as “N-parking range” in some cases) to the parking range is conducted, the parking lock command portion commands the locking mechanism portion to maintain a state where the position of the piston is locked at the second position, and then issues a command to drive the actuator.

When such control is conducted, the piston of the actuator does not move as long as the locking mechanism portion normally functions. In other words, the movement of the piston is restrained by mechanical locking at the second position by the locking mechanism portion.

On the other hand, when the locking mechanism portion is in a failure in the unlocked (released) state, the piston of the actuator moves and after a lapse of a predetermined time, moves out of the second position. In this case, the parking lock failure determination portion determines that the locking mechanism portion is in a failure in the unlocked state.

As described above, with the control device of the automatic transmission according to the present aspect, it is possible to detect that the locking mechanism portion is in a failure in the unlocked state without providing a sensor for detecting the locked state to the locking mechanism portion. Accordingly, as compared with the technique disclosed in JP 2007-303680 A, the number of sensors provided can be reduced.

Thus, the control device of the automatic transmission according to the present aspect is capable of suppressing an increase in manufacturing cost while ensuring high reliability.

In a control device of an automatic transmission according to another aspect of the present invention, with the above structure, the piston has a first surface and a second surface provided back to back in a direction of the movement, and the actuator is a hydraulic actuator further including a hydraulic chamber to which the first surface faces and a return spring which applies an elastic force to the second surface.

Then, the actuator drive command portion of the control device according to the present aspect issues a command to discharge an oil pressure of the hydraulic chamber when the piston is caused to move from the second position to the first position.

The control device of the automatic transmission according to the present aspect is designed to move the piston of the actuator from the second position to the first position by discharging an oil pressure from the hydraulic chamber. Accordingly, when the present aspect is adopted, even if there occurs a situation where no oil pressure can be supplied for some reason, the piston can be moved to the first position by an elastic force of the return spring, so that the parking mechanism portion is brought into a parking state where the rotation of the power transmission shaft is restrained.

Thus, the control device of the automatic transmission according to the present aspect is advantageous in ensuring higher safety.

The automatic transmission as a target to be controlled by the control device according to a still another aspect of the present invention further includes a position detection portion which detects that the piston is at the second position.

Then, the parking lock failure determination portion of the control device of the automatic transmission according to the present aspect determines that the piston goes out of the second position on the basis of position detection information of the piston from the position detection portion.

In the control device of the automatic transmission according to the present aspect, one position detection portion enables two detections, i.e., detection of a position of the piston (whether the parking lock mechanism portion is in the restraining state or in the restraining released state) and detection of a failure of the locking mechanism portion in the unlocked state. Thus, it is advantageous in ensuring higher reliability while suppressing an increase in manufacturing cost.

A control device of an automatic transmission according to a still another aspect of the present invention further includes a vehicle state determination portion, with the above structure. The vehicle state determination portion is a portion which obtains information whether or not a vehicle is in a stopped state and when the vehicle is in the stopped state and the shift position is in other range than the parking range, determines that an unlock failure diagnosis is available.

Then, in the control device of the automatic transmission according to the present aspect, the parking lock command portion commands the locking mechanism portion to bring a state where the position of the piston is mechanically locked at the second position when the vehicle state determination portion determines that the unlock failure diagnosis is available; the actuator drive command portion, when the vehicle state determination portion determines that the unlock failure diagnosis is available, commands the actuator to move the piston from the second position to the first position after the parking lock command portion issues a command to bring the state where the position of the piston is mechanically locked at the second position; and the parking lock failure determination portion, when determining that the position of the piston moves from the second position within a predetermined time after the actuator drive command portion issues a command to drive the piston, in a case where the vehicle state determination portion determines that the unlock failure diagnosis is available, determines that the locking mechanism portion is in a failure in the unlocked state.

The control device of the automatic transmission according to the present aspect is configured to, when the vehicle state determination portion determines that the unlock failure diagnosis is available, check whether or not the locking mechanism portion is in a failure in the unlocked state even if the operation of shifting the shift position from the N-parking range to the parking range is not conducted.

Thus, the control device of the automatic transmission according to the present aspect enables failure check of the locking mechanism portion in the unlocked state with high frequency to have an advantage in ensuring higher reliability.

In a control device of an automatic transmission according to a still another aspect of the present invention, in the above structure, the actuator drive command portion commands the actuator to move the piston to the second position after the determination by the parking lock failure determination portion.

In the control device of the automatic transmission according to the present aspect, after conducting failure check when the vehicle state determination portion determines that the unlock failure diagnosis is available, a command is issued to drive the piston to the second position. Accordingly, control to be conducted when the shift position is in the N-parking range is returned. Thus, the control device of the automatic transmission according to the present aspect prevents a driver driving a vehicle from feeling uncomfortable while conducting failure check of the locking mechanism portion with high frequency.

A control device of an automatic transmission according to a still another aspect of the present invention, in the above structure, further includes a warning command portion which issues a command to give warning when the parking lock failure determination portion determines that the locking mechanism portion is in a failure in the unlocked state.

Since the control device of the automatic transmission according to the present aspect includes the warning command portion, it is possible to make a driver acknowledge a failure of the locking mechanism portion. Thus, the control device of the automatic transmission according to the present aspect enables a driver to be urged to quickly respond to a failure of the locking mechanism portion.

As a specific warning command portion, it is possible to adopt, for example, a device which executes warning display on an information display, lighting of a warning lamp, and warning by a warning sound or voices. Additionally, failure information may be directly transmitted to servers at manufacturers or shops by wireless.

The control device of the automatic transmission according to each of the above aspects is capable of suppressing an increase in manufacturing cost while ensuring high reliability.

This application is based on Japanese Patent application No. 2016-173501 filed in Japan Patent Office on Sep. 6, 2016, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A control device of an automatic transmission, wherein
the automatic transmission is provided in a power transmission path between a drive source and a wheel, and includes:
a power transmission shaft which transmits power to the wheel;
a parking mechanism portion which enters a restraining state of restraining rotation of the power transmission shaft when a shift position is in a parking range, and enters a restraining released state of releasing restraining of the rotation of the power transmission shaft when the shift position is in other range than the parking range;
an actuator which has a piston freely movable between a first position and a second position, the piston being coupled to the parking mechanism portion, and brings the parking mechanism portion into the restraining state by setting the piston to the first position, and brings the parking mechanism portion into the restraining released state by setting the piston to the second position; and
a locking mechanism portion which mechanically locks a position of the piston when the piston of the actuator is at the second position, and
the control device is a shift-by-wire control device, and includes:
a shift position determination portion which obtains information related to the shift position to determine that operation of shifting the shift position from the other range than the parking range to the parking range is conducted;
a parking lock command portion which commands the locking mechanism portion to maintain a state where a position of the piston is mechanically locked at the second position when the shift position determination portion determines that the operation of shifting the shift position from the other range than the parking range to the parking range is conducted;
an actuator drive command portion which commands the actuator to drive the piston from the second position to the first position in a state where the parking lock command portion issues a command to maintain the state where the position of the piston is mechanically locked at the second position; and
a parking lock failure determination portion which, when determining that the position of the piston goes out of the second position within a predetermined time after the actuator drive command portion issues a command to drive the piston, determines that the locking mechanism portion is in a failure in an unlocked state.

2. The control device of the automatic transmission according to claim 1, wherein
the piston has a first surface and a second surface provided back to back in a direction of movement,
the actuator is a hydraulic actuator further having a hydraulic chamber to which the first surface faces and having a return spring which applies an elastic force to the second surface, and
the actuator drive command portion issues a command to discharge an oil pressure of the hydraulic chamber when the piston is caused to move from the second position to the first position.

3. The control device of the automatic transmission according to claim 1, wherein
the automatic transmission further includes a position detection portion which detects that the piston is at the second position, and
the parking lock failure determination portion determines that the piston goes out of the second position based on position detection information of the piston from the position detection portion.

4. The control device of the automatic transmission according to claim 1, further comprising a vehicle state determination portion which obtains information whether a vehicle is in a stopped state or not, and determines that an unlock failure diagnosis is available when the vehicle is in the stopped state and the shift position is in the other range than the parking range, wherein
the parking lock command portion commands the locking mechanism portion to bring the state where the position of the piston is mechanically locked at the second position when the vehicle state determination portion determines that the unlock failure diagnosis is available,
the actuator drive command portion, when the vehicle state determination portion determines that the unlock failure diagnosis is available, commands the actuator to move the piston from the second position to the first position after the parking lock command portion issues a command to bring the state where the position of the piston is mechanically locked at the second position; and
the parking lock failure determination portion, when determining that the position of the piston goes out of the second position within a predetermined time from when the actuator drive command portion issues a command to drive the piston, in a case where the vehicle state determination portion determines that the unlock failure diagnosis is available, determines that the locking mechanism portion is in a failure in the unlocked state.

5. The control device of the automatic transmission according to claim 4, wherein the actuator drive command portion commands the actuator to drive the piston to the second position after determination by the parking lock failure determination portion.

6. The control device of the automatic transmission according to claim 1, further comprising a warning command portion which issues a command to give warning when the parking lock failure determination portion determines that the locking mechanism portion is in a failure in the unlocked state.
